(19) United States
(12) Patent Application Publication
(10) Pub. No.: US 2017/0027114 A1
(43) Pub. Date: Feb. 2, 2017

(54) REVERSIBLE DECORATIVE MINIATURE GARDEN PLATE

(71) Applicant: Barbara Jean Allen, Woodbury, MN (US)

(72) Inventor: Barbara Jean Allen, Woodbury, MN (US)

(21) Appl. No.: 15/293,685

(22) Filed: Oct. 14, 2016

Related U.S. Application Data
(63) Continuation-in-part of application No. 14/563,611, filed on Dec. 8, 2014.
(60) Provisional application No. 61/968,192, filed on Mar. 20, 2014.

(51) Int. Cl. A01G 13/02; A01G 9/02

(52) U.S. Cl. CPC A01G 13/0281; A01G 9/02; A01G 9/028

(57) ABSTRACT

A decorative miniature garden apparatus and kit is provided. The decorative miniature garden of the present invention may at least include a plate having an upper surface, a lower surface, and an outer perimeter forming an edge. An opening is formed through the plate and is sized to receive a plant within. The upper surface and the lower surface of the plate may include at least one decoration depicting a miniature garden scene or outdoor screen. A plant may be placed within a container and the plate may be placed within the container so that the plant is protruding through the opening.

### CROSS-REFERENCE TO RELATED APPLICATION

This application is a continuation in part of U.S. non-provisional application Ser. No. 14/563,611, filed Dec. 8, 2014 which claims the benefit of priority of U.S. provisional application No. 61/968,192, filed Mar. 20, 2014, the contents of which are herein incorporated by reference.

### BACKGROUND OF THE INVENTION

The present invention relates to a miniature garden and, more particularly, to a decorative miniature garden plate.

A miniature garden is a small garden with accessories arranged in pots or containers. When a miniature garden is created, soil and stones are needed in order to make a base for the garden. Therefore, current miniature gardens are messy and the pot becomes heavy. Also, to create a well structured miniature garden, the maker must have talent, patience, and an extended period of time. Most individuals do not have the ability or the time to prepare the miniature garden.

As can be seen, there is a need for a quick and easy way to create a miniature garden.

### SUMMARY OF THE INVENTION

In one aspect of the present invention, a miniature garden apparatus comprises: a plate comprising an upper surface, a lower surface opposite the upper surface, and an outer perimeter forming an edge, wherein at least one opening is formed through the plate and is sized to receive a plant within; and a first decoration disposed on the upper surface of the plate; and a second decoration disposed on the lower surface of the plate, wherein the first decoration is different than the second decoration.

In another aspect of the present invention, a miniature garden kit comprises: a plate comprising an upper surface, a lower surface opposite the upper surface, and an outer perimeter forming an edge, wherein at least one opening is formed through the plate, wherein a first decoration is disposed on the upper surface of the plate, and a second decoration is disposed on the lower surface of the plate, wherein the first decoration is different than the second decoration; a container comprising a bottom, and a sidewall having an inner surface and an outer surface, wherein the plate is sized it fit within the container so that the edge of the plate rests against the inner surface, and a gap is formed between the plate and the bottom; and at least one pot comprising a bottom and a sidewall comprising an upper rim, wherein the pot is sized to fit within the gap underneath the opening of the plate.

These and other features, aspects and advantages of the present invention will become better understood with reference to the following drawings, description and claims.

### BRIEF DESCRIPTION OF THE DRAWINGS

FIG. 1 is a perspective view of a first configuration of the present invention;

FIG. 2 is an exploded perspective view of the first configuration of the present invention;

FIG. 3 is a perspective view of a second configuration illustrating the upper side of the present invention;

FIG. 4 is a perspective view of the upper side of the decorative plate of the second configuration;

FIG. 5 is a perspective view of the upper side of the decorative plate of the second configuration in use;

FIG. 6 is a perspective view of the second configuration illustrating the lower side of the present invention;

FIG. 7 is a perspective view of the lower side of the decorative plate of the second configuration; and

FIG. 8 is a perspective view of the lower side of the decorative plate of the second configuration n in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a plate that is used with plants in a pot in order to create a decorative miniature garden. The decorative plate of the present invention fits into standard pots, and eliminates the need for soil and stones. The plates include openings in which plants may fit through. The plate may be made of various materials, such as but not limited to, ceramic, which includes glazing and firing in a kiln. A square, rectangular, round or oval, etc. shape is created with one or more holes for plants or flowers. Decorations are arranged in a pattern on the upper and lower surfaces of the plate in order to replicate natural and artificial elements of a garden or other outdoor scene. No assembly is required except for the addition of plants or flowers. The result is a light weight, attractive and clean miniature garden.

Different decorations and plate designs may be used to create different scenes, such as seasons and personal celebrations. For example, the plates may include a Christmas theme, a wedding theme, a golf theme, a Halloween theme, a Thanksgiving theme, an Easter theme and the like. Additionally, the present invention may be used as a table centerpiece with floral bouquets. The hole in the plate offers the flexibility of adding lighting. An instant fairy garden with a Christmas scene may be enhanced by lighting.

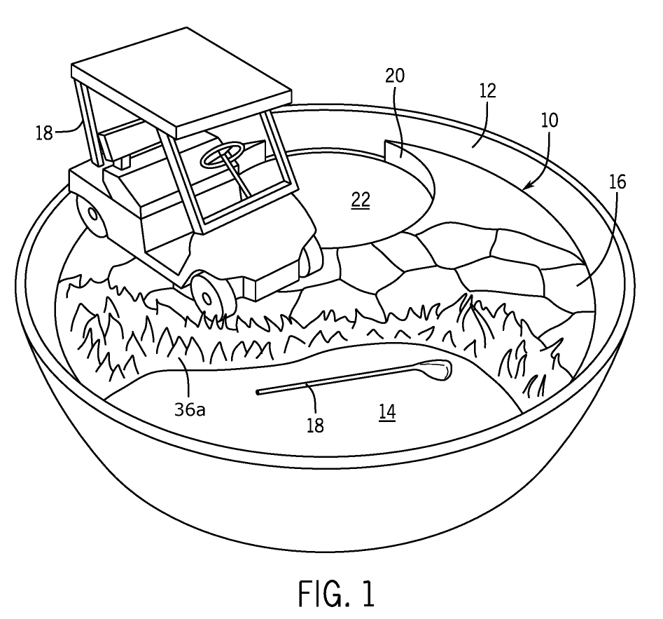

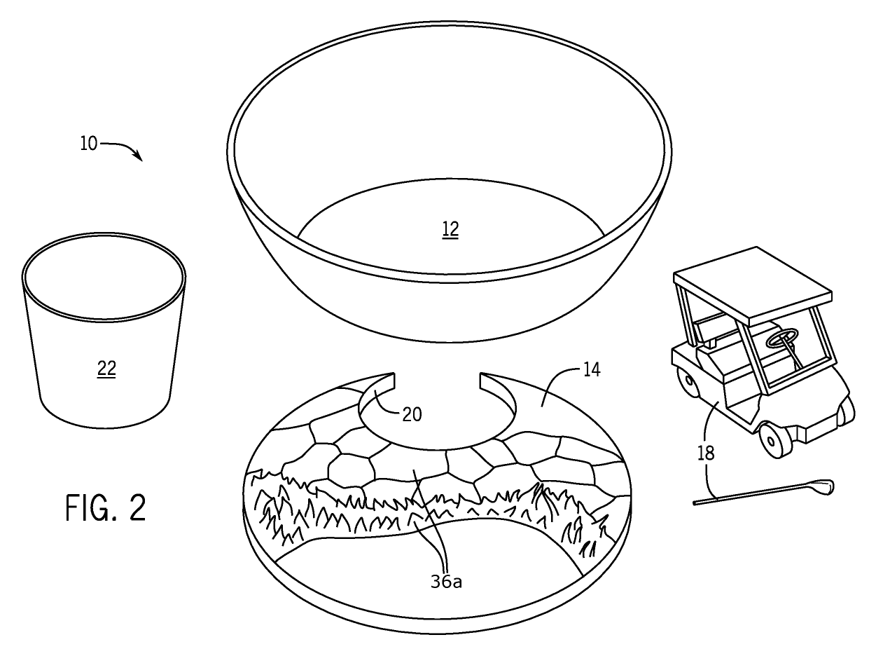

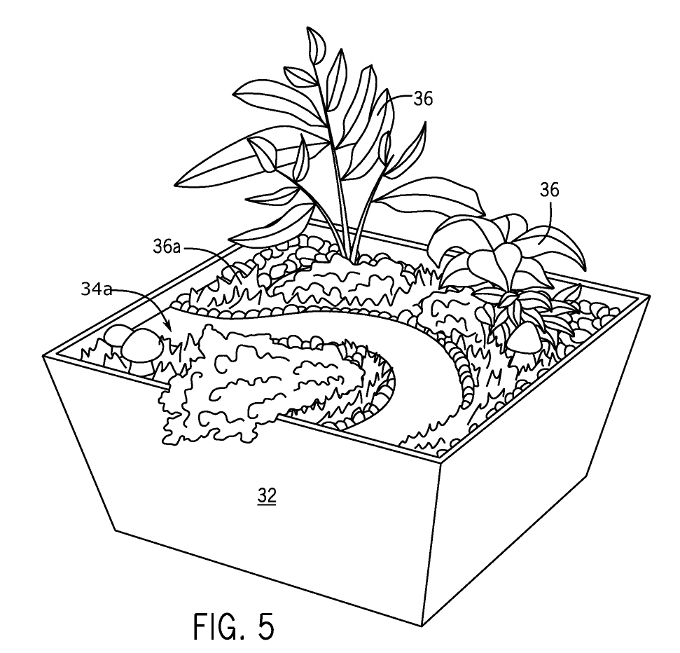

Referring to FIGS. 1 through 5, the present invention includes a decorative miniature garden apparatus and kit 10. The decorative miniature garden 10 of the present invention may at least include a plate 14 having an upper surface 34a, a lower surface 34b opposite the upper surface 34a, and an outer perimeter forming an edge. An opening 20 is formed through the upper and lower surfaces 34a, 34b of the plate 14. The opening 20 is sized to receive a plant 36 within. The upper surface 34a and the lower surface 34b of the plate 14 may include at least one decoration 36a, 36b. For example, the upper surface 34a may include a first decoration 36a and the lower surface 34b may include a second decoration 36b different than the first decoration 36a. The plant 36 may be placed within a container 12 and the plate 14 may be placed within the container 12 so that the plant 36 is protruding through the opening 20.

The container 12 of the present invention includes a bottom, and a sidewall having an inner surface and an outer surface. The plate 14 is sized to fit within the container 12 so that the edge of the plate 14 rests against the inner surface, and a gap is formed between the plate 14 and the bottom. The container 12 may be circular, rectangular or square shaped. The plate 14 may correspond with the container, and thereby be circular, rectangular or square shaped to fit properly within the container 12. The present invention may further include a plant pot 22. The plant pot 22 may be sized to fit within the opening of the plate 14. Further, the plant pot 22 is disposed in between the plate 14 and the bottom of the container 12 so that the plant 36 may protrude from the opening. The pot 22 includes a bottom and a sidewall forming an upper rim. In certain embodiments, the upper rim of the pot 22 may fit within the opening of the plate 14. The present invention may further include a plurality of pots 22. In such embodiments, the plate 14 may include a plurality of openings 20 to receive the plants 36 within each of the pots 22.

The decorations 36a, 36b of the present invention may include a plurality of decorations 36a, 36b formed on the upper surface 34a and lower surface 34b of the plate 14. For example, the decorations 36a, 36b may include, but are not limited to, a replication of at least one of soil, water, stones, sidewalks, pathways, plants, mushrooms, and sand. The decorations 36a, 36b may be painted or sculpted into the upper and lower surface 34a, 34b. The present invention may further include decorative accessories 18. For example, when the plate 14 mimics a golf course scene, the present invention may include miniature replica golf carts and golf clubs. Further, for a Christmas scene, the decorative accessories 18 may include sleighs, and reindeer. Each of the plates 14 may be made with decorations 16 based on certain themes and optionally corresponding accessories 18.

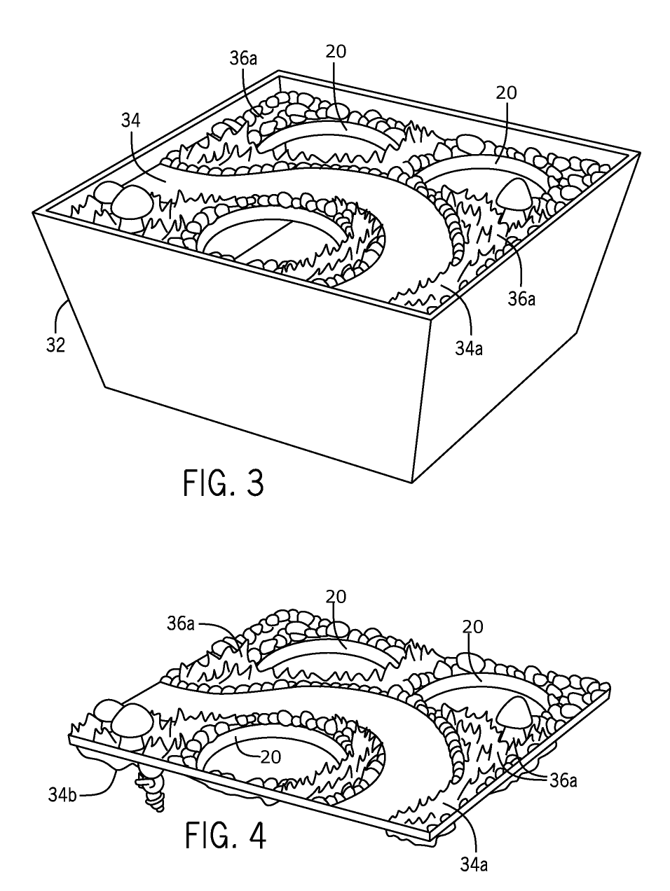

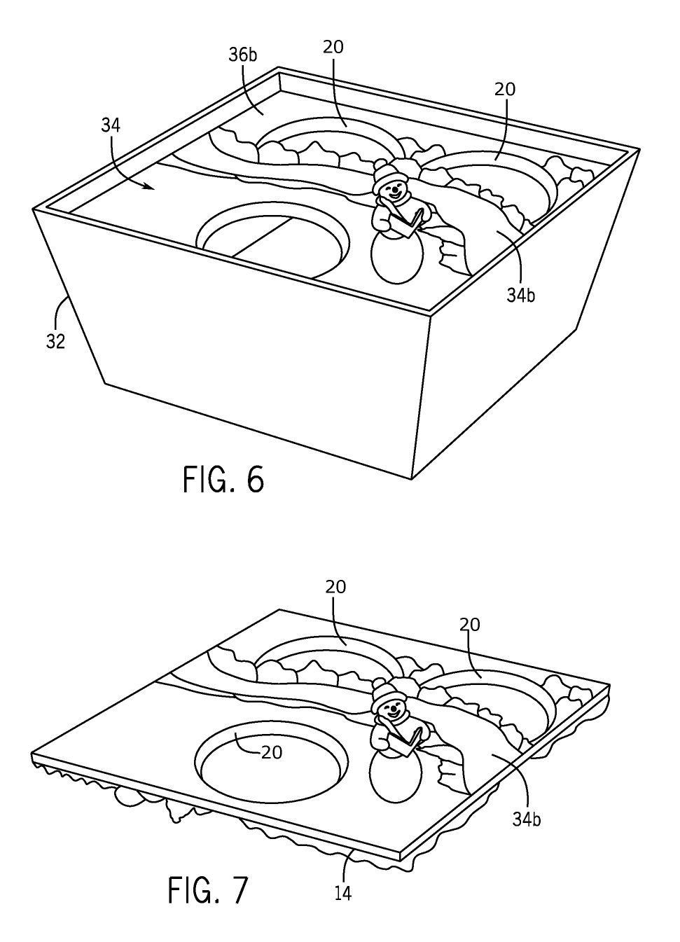

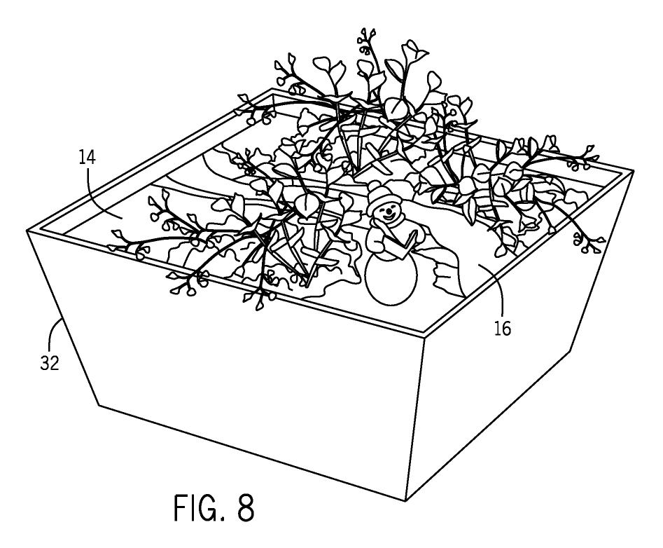

In certain embodiments, the upper surface 34a may include a plurality of first decorations 36a to form a first scene and the lower surface 34b may include a plurality of decorations 36b to form a second scene different from the first scene. As illustrated in FIG. 3 through 8, the upper surface 34a may include a summer scene and the lower surface 34b may include a winter scene. The upper surface 34a of the plate 14 and the lower surface 34b opposite the upper surface 34a are each fabricated with a separate miniature garden scene or other outdoor scene, which are both complete and ready for immediate use by a user. Therefore, the same plate 14 may be flipped to change scenes.

The present invention may come in a kit 10. For example, the kit 10 may include the plate 14 with decorations 36a, 36b, the corresponding container 12, and a plant pot 22 sized to fit between the plate 14 and the container bottom. Further, if there is more than one opening 22 through the plate 14, the kit 10 may come with more than one plant pot 22. Further, in alternate embodiments, the kit 10 may include different accessories 18 to place on the plate 14 after the present invention has been put together.

A method of assembling the present invention may include the following. A user may fill the pot 22 with dirt and a plant 46. The pot 22 and plant 46 may be placed within the container 12, resting on the bottom of the container 12. The plate 14 may be placed within the container 12 so that the opening 22 aligns with the pot 22 and plant 36. The accessories 18 may be placed or attached to the plate 14 and the miniature garden is complete.

It should be understood, of course, that the foregoing relates to exemplary embodiments of the invention and that modifications may be made without departing from the spirit and scope of the invention as set forth in the following claims.

What is claimed is:

1. A miniature garden apparatus comprising:
a plate comprising an upper surface, a lower surface opposite the upper surface, and an outer perimeter forming an edge, wherein at least one opening is formed through the upper and lower surface of the plate and is sized to receive a plant within; and
a first decoration disposed on the upper surface of the plate; and
a second decoration disposed on the lower surface of the plate, wherein the first decoration is different than the second decoration.

2. The miniature garden apparatus of claim 1, wherein the first and second decorations comprise a replication of at least one of soil, water, stones, sidewalks, pathways, plants, mushrooms, and sand.

3. The miniature garden apparatus of claim 1, further comprising a container comprising a bottom, and a sidewall having an inner surface and an outer surface, wherein the plate is sized it fit within the container so that the edge of the plate rests against the inner surface, and a gap is formed between the plate and the bottom.

4. The miniature garden apparatus of claim 3, further comprising a plant pot sized to below the opening and disposed in between the plate and the bottom of the container.

5. The miniature garden apparatus of claim 1, wherein the at least one opening is a plurality of openings.

6. A miniature garden kit comprising:
a plate comprising an upper surface, a lower surface opposite the upper surface, and an outer perimeter forming an edge, wherein at least one opening is formed through the plate, wherein a first decoration is disposed on the upper surface of the plate, and a second decoration is disposed on the lower surface of the plate, wherein the first decoration is different than the second decoration;
a container comprising a bottom, and a sidewall having an inner surface and an outer surface, wherein the plate is sized it fit within the container so that the edge of the plate rests against the inner surface, and a gap is formed between the plate and the bottom; and
at least one pot comprising a bottom and a sidewall comprising an upper rim, wherein the pot is sized to fit within the gap underneath the opening of the plate.

7. The miniature garden kit of claim 6, wherein the first and second decoration comprises a replication of at least one of soil, water, stones, sidewalks, pathways, plants, mushrooms, and sand.

8. The miniature garden kit of claim 6, wherein the at least one pot is a plurality of pots and the at least one opening is a plurality of openings.
